(19) United States
(12) Patent Application Publication
(10) Pub. No.: US 2014/0358631 A1
(43) Pub. Date: Dec. 4, 2014

(54) METHOD AND APPARATUS FOR GENERATING FREQUENTLY ASKED QUESTIONS

(71) Applicant: 24/7 Customer, Inc., Campbell, CA (US)

(72) Inventors: Abhishek Ghose, Navi Mumbai (IN); Venkata Jaganmohan Rao Goru, Bangalore (IN); Lingaraj B. Belaldavar, Bangalore (IN); V. Rakesh Reddy, Hyderabad (IN); Makrand Patwardhan, Bangalore (IN); Sachin Joshi, Solapur (IN)

(21) Appl. No.: 14/294,013

(22) Filed: Jun. 2, 2014

Related U.S. Application Data
(60) Provisional application No. 61/830,352, filed on Jun. 3, 2013.

(51) Int. Cl. G06Q 30/02

(52) U.S. Cl. CPC G06Q 30/0201; G06Q 30/0282
USPC 705/7.29

(57) ABSTRACT

In accordance with an example embodiment a computer-implemented method and an apparatus for generating FAQs is provided. The method comprises receiving interaction data corresponding to interactions between a plurality of users and customer support representatives by a processor. A plurality of user parameters associated with the plurality of users is also received by the processor. A plurality of clusters is generated from the interaction data based on the plurality of user parameters. The method further comprises determining one or more visitor parameters corresponding to a visitor on an interaction medium. At least one cluster related to the visitor from among the plurality of clusters is identified based on the one or more visitor parameters. Further, at least one FAQ is generated based on the identified at least one cluster. The method further comprises providing the generated at least one FAQ to the visitor on the interaction medium by the processor.

### CROSS REFERENCE TO RELATED APPLICATIONS

This application claims priority to U.S. provisional patent application Ser. No. 61/830,352, filed Jun. 3, 2013, which application is incorporated herein in its entirety by this reference thereto.

### TECHNICAL FIELD

The present technology generally relates to online support services and more particularly to generating frequently asked questions for assisting online visitors.

### BACKGROUND

Websites of enterprises routinely attract visitors, who visit the websites to obtain product information, to receive purchase assistance, to make customer service queries and so forth. In some cases, the websites include a ‘Frequently Asked Questions’ (FAQs) section to offer assistance to the visitors with queries or concerns that the visitors may have and which may not be directly addressed by the information present on the websites. The FAQs section contains a list of most often asked questions related to a product/service or a specific domain along with the corresponding answers. The list may be a collection of most basic questions that a website content provider anticipates to be often asked or may be constructed based on historic activities of a specific group of visitors. In some cases, the website content provider may manually write the questions and answers to configure the list and provide the list on a static webpage. In some cases, the list corresponding to the FAQs section might be substantially long and it may be cumbersome for the visitors to scroll through the entire list to obtain answers for their queries. In some scenarios, the FAQs section may not cover specific queries or issues that the visitors are seeking answers for. For example, a visitor may be intending to purchase a laptop through the website and is unable to find any option for express shipping on the website. As a result, the visitor may look-up at the FAQs section to retrieve answers related to options for express shipping. However, sometimes even after scrolling through the entire list of FAQs, the visitor may still not find any solution and may end-up spending time unnecessarily in filling pre-chat forms, waiting for the chat to get connected, speaking with a customer support representative and the like. Accordingly, there is need to decrease the visitor time spent on seeking answers to their queries and improving an experience and satisfaction quotient for online visitors.

### SUMMARY

Various apparatuses, methods, and computer readable mediums for generating frequently asked questions (FAQs) are disclosed. In an embodiment, a computer-implemented method includes receiving interaction data corresponding to interactions between a plurality of users and customer support representatives. A plurality of user parameters associated with the plurality of users is also received by the processor. The method further includes generating a plurality of clusters from the interaction data based on the plurality of user parameters. Each cluster from among the plurality of clusters is associated with at least one user parameter from among the plurality of user parameters. Each cluster includes one or more questions from among a plurality of questions asked during the interactions along with the corresponding answers, where the one or more questions and the corresponding answers are related to the at least one user parameter. The method further includes determining one or more visitor parameters corresponding to a visitor on an interaction medium by the processor. At least one cluster related to the visitor from among the plurality of clusters is identified based on the one or more visitor parameters by the processor. Further, at least one frequently asked question (FAQ) is generated based on the identified at least one cluster by the processor. The method further includes providing the at least one FAQ to the visitor on the interaction medium by the processor.

In another embodiment, the apparatus for generating FAQs is disclosed. The apparatus includes at least one processor and a memory. The memory is adapted to store machine executable instructions therein, that when executed by the at least one processor, cause the apparatus to receive interaction data corresponding to interactions between a plurality of users and customer support representatives. The apparatus is further caused to receive a plurality of user parameters associated with the plurality of users. The apparatus is further configured to generate a plurality of clusters from the interaction data based on the plurality of user parameters. Each cluster from among the plurality of clusters is associated with at least one user parameter from among the plurality of user parameters. Each cluster includes one or more questions from among a plurality of questions asked during the interactions along with the corresponding answers, where the one or more questions and the corresponding answers are related to the at least one user parameter. The apparatus is further configured to determine one or more visitor parameters corresponding to a visitor on an interaction medium by the processor. At least one cluster related to the visitor from among the plurality of clusters is identified based on the one or more visitor parameters by the processor. Further, at least one frequently asked question (FAQ) is generated based on the identified at least one cluster by the processor. The apparatus is further configured to provide the at least one FAQ to the visitor on the interaction medium by the processor.

Moreover, in an embodiment, a non-transitory computer-readable medium storing a set of instructions that when executed cause a computer to perform a method for generating FAQs is disclosed. The method further includes receiving interaction data corresponding to interactions between a plurality of users and customer support representatives. A plurality of user parameters associated with the plurality of users is also received. The method further includes generating a plurality of clusters from the interaction data based on the plurality of user parameters. Each cluster from among the plurality of clusters is associated with at least one user parameter from among the plurality of user parameters. Each cluster includes one or more questions from among a plurality of questions asked during the interactions along with the corresponding answers, where the one or more questions and the corresponding answers are related to the at least one user parameter. The method further includes determining one or more visitor parameters corresponding to a visitor on an interaction medium. At least one cluster related to the visitor from among the plurality of clusters is identified based on the one or more visitor parameters. Further, at least one frequently asked question (FAQ) is generated based on the identified at least one cluster. The method further includes providing the at least one FAQ to the visitor on the interaction medium.

### BRIEF DESCRIPTION OF THE FIGURES

FIG. 1 is a schematic diagram showing an example environment in which various embodiments of the present technology may be practiced;

FIG. 2 is a block diagram of an example apparatus configured to generate FAQs in accordance with an embodiment;

FIG. 3 is a schematic diagram showing an example sequence of operations performed by the apparatus of FIG. 2 in accordance with an embodiment;

FIG. 4 illustrates a schematic diagram for illustrating an example generation of clusters from interaction data in accordance with an embodiment;

FIG. 5 illustrates a schematic diagram showing an example generation of FAQs in accordance with an embodiment;

FIG. 6 illustrates a first example screenshot of a visitor device screen showing example FAQs provided to a visitor in accordance with an embodiment;

FIG. 7 illustrates a second example screenshot of the visitor device screen showing example FAQs provided to a visitor in accordance with an embodiment;

FIG. 8 illustrates a flow diagram of a first example method for generating FAQs in accordance with an example embodiment; and

FIG. 9 illustrates a flow diagram of a second example method for generating FAQs in accordance with an example embodiment.

### DETAILED DESCRIPTION

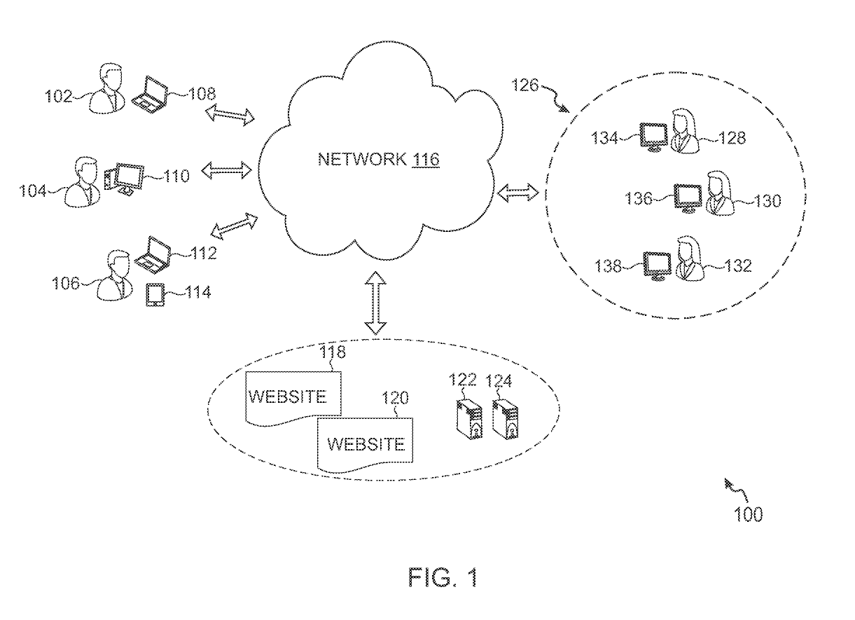

FIG. 1 is a schematic diagram showing an example environment 100 in which various embodiments of the present technology may be practiced. The environment 100 depicts a plurality of users, such as users 102, 104 and 106 (hereinafter collectively referred to as users 102-106) located at different geographical locations. It is understood that the environment 100 is depicted to include three visitors for illustration purposes and that the environment 100 may include a plurality of users, such as the users 102-106. Each user is associated with one or more electronic devices. For example, the user 102 is associated with an electronic device 108, the user 104 is associated with an electronic device 110 and the user 106 is associated with electronic devices 112 and 114 respectively. Examples of the electronic devices 108, 110, 112, and 114 (hereinafter collectively referred to as electronic devices 108-114) may include laptops, tablet computers, personal computers, mobile phones, Smartphones, personal digital assistants, Smart watches, web-enabled pair of glasses and the like. The electronic devices 108-114 are capable of connecting to a network 116 for accessing the World Wide Web (also referred to herein as the Web). Examples of the network 116 may include wired networks, wireless networks or a combination thereof. Examples of wired networks may include Ethernet, local area network (LAN), fiber-optic cable network and the like. Examples of wireless network may include cellular networks like GSM/3G/CDMA networks, wireless LAN, blue-tooth or Zigbee networks and the like. Examples of combination of wired and wireless networks may include the Internet.

In an example scenario, a user may access one or more websites, such as websites 118 and 120 on the Web for locating content of interest. The websites 118 and 120 may be hosted on web servers, such as web servers 122 and 124, which may be accessed via the network 116. Examples of the websites 118 and 120 may include enterprise websites, news portals, gaming portals, educational websites, e-commerce websites, social networking websites and the like. It is understood that the environment 100 is depicted to include the two websites 118 and 120 for example purposes and that the Web may include a plurality of such websites. In some example scenarios, the users 102-106 may be familiar with various services available on the Web for locating the content of interest. During a web journey, a user may access one or more web pages, (such as web pages associated with any of the websites 118 and 120) following a path to satisfy a specific need. The term ‘journey’ as described herein refers to a path a user may take to reach his/her goal when using a particular interaction medium, such as a website or a native mobile application. For example, the web journey (i.e. a journey on a website) may include a number of web pages and decision points that carry the user from one step to another step. The term ‘the web journey’ may also include anything from a simple visit to one page where no direct interaction with customer support representatives takes place, to complex multipage visits that include interaction such as for example, but not limited to, for searching a product, for applying for an insurance quote, for making a purchase, for posting and commenting on user generated content, and the like.

In some example scenarios, the users 102-106 may visit the websites 118 and 120 to obtain product information, to receive purchase assistance, to make customer service queries and so forth. In some example scenarios, the user may not be satisfied from content present on the website and may prefer to communicate with a customer support representative at a customer support center. The customer support center may include a plurality of agents, chat bots, self assist systems such as either web or mobile digital self-service and/or interactive voice response (IVR) systems and the like. The agents, chat bots, self assist systems such as either web or mobile digital self-service and/or interactive voice response (IVR) systems at a customer support center are collectively referred to herein as customer support representatives and singularly as a customer support representative. Such a customer support center 126 including a plurality of customer support representatives is depicted in environment 100. The customer support center 126 is depicted to include three customer service representatives 128, 130 and 132 (hereinafter collectively referred to as customer support representatives 128-132) for example purposes. Each customer support representative is associated with an electronic device for engaging in a conversation (such as an interactive chat conversation) for providing assistance to one or more users, such as the users 102-106 on the website. For example, the customer support representative 128 is associated with an electronic device 134, the customer support representative 130 is associated with an electronic device 136 and the customer support representative 132 is associated with an electronic device 138. During a web journey, the users 102-106 may seek assistance from the customer support representatives 128-132 upon not being able to address their needs with the content on the website. In such scenarios, the users 102-106 may end up spending a large amount of time in filling pre-chat forms, waiting for the chat to get connected, interacting with a customer support representative and the like.

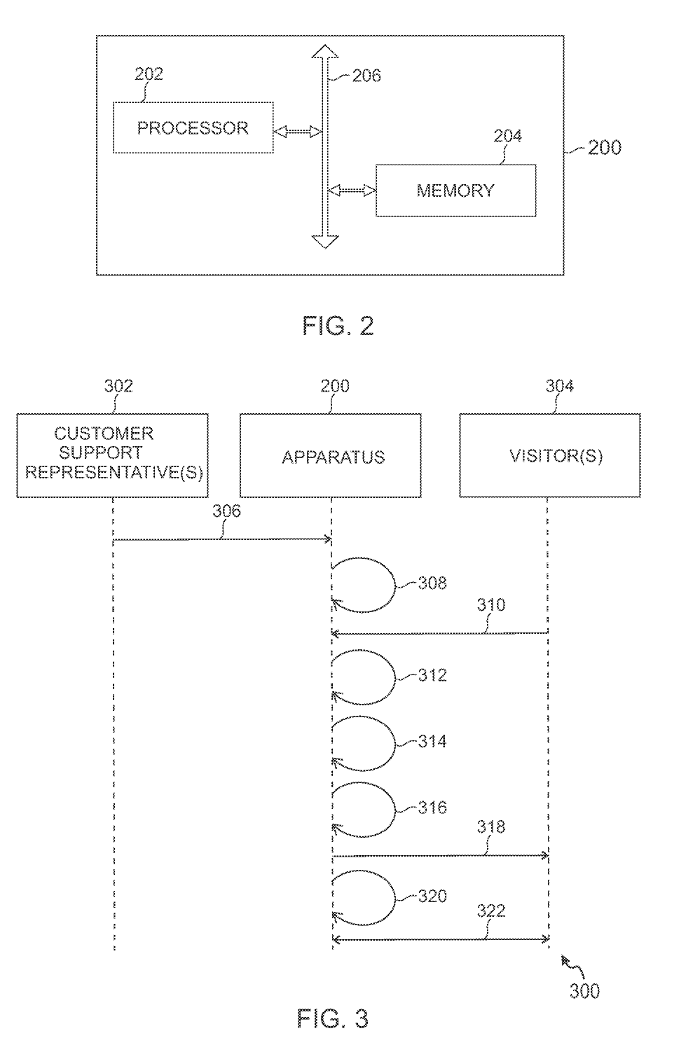

In order to save user's time, in some cases, the websites 118 and 120 may include a ‘Frequently Asked Questions’ (FAQs) section to offer assistance to the users 102-106 with queries or concerns that the users 102-106 may have and which may not be directly addressed by the information present on the websites. The FAQs section contains a list of most often asked questions, for example, related to a product/service or a specific domain along with the corresponding answers. The list may be a collection of most basic questions that a website content provider anticipates to be often asked or may be constructed based on historic activities of a specific group of users. In some cases, the website content provider may manually write the questions and answers to configure the list and provide the list on a static webpage. In some cases, the list corresponding to the FAQs section might be substantially long and it may be cumbersome for the users to scroll through the entire list to obtain answers for their queries. In some scenarios, the FAQs section may not cover specific queries or issues that the users 102-106 are seeking answers for. However, sometimes even after scrolling through the entire list of FAQs, the users 102-106 may still not find any solution for their issues. Various embodiments of the present technology, however, provide methods and apparatuses for generating FAQs that are capable of overcoming these and other obstacles and providing additional benefits. More specifically, methods and apparatuses disclosed herein suggest dynamic generation of FAQs, which are specific to a visitor and his/her journey thereby decreasing the visitor's time spent on seeking answers to their queries and improving a visitor experience and satisfaction quotient. An example apparatus configured to generate FAQs is explained with reference to FIG. 2.

FIG. 2 is a block diagram of an example apparatus 200 configured to generate FAQs in accordance with an embodiment. In an embodiment, the apparatus 200 may be embodied as a web server communicably associated with the website, such as the websites 118 or 120 of FIG. 1, and the customer support center, such as the customer support center 126 associated with an enterprise corresponding to the website. Pursuant to an exemplary scenario, the apparatus 200 may be any machine capable of executing a set of instructions (sequential and/or otherwise) so as to generate FAQs.

The apparatus 200 includes at least one processor, such as the processor 202 and a memory 204. It is noted that though the apparatus 200 is depicted to include only one processor, the apparatus 200 may include more number of processors therein. In an embodiment, the processor 202 and the memory 204 are configured to communicate with each other via or through a bus 206. Examples of the bus 206 may include, but are not limited to, a data bus, an address bus, a control bus, and the like. The bus 206 may be, for example, a serial bus, a bi-directional bus or a unidirectional bus.

In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed. The processor 202 may include, among other things, a clock, an arithmetic logic unit (ALU) and logic gates configured to support an operation of the processor 202. The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

In an embodiment, the memory 204 is configured to receive interaction data corresponding to interactions between a plurality of users and customer support representatives for example from a customer support center. In an embodiment, the memory 204 is further configured to store the interaction data. In an embodiment, the interactions correspond to chat interactions between the plurality of users and the customer support representatives. For example, users may engage in chat interactions with customer support representatives through phones, chat applications, email, SMS and the like, such as to get solutions or suggestions related to a specific product or service. In an example embodiment, the chat interactions correspond to at least one of text chat interactions, voice chat interactions and video chat interactions. In an embodiment, the interaction data is embodied in a textual form and may include textual content corresponding to text chat interactions, transcripts of voice chat interactions, transcripts of video chat interactions and the like.

In an embodiment, the interaction data may include questions asked by the users and the corresponding answers provided by the customer support representatives. For example, if the intent of a user is to purchase a laptop online and requires express delivery, but the user (even after accessing a portion of the website or the entire website) does not find any option for express delivery, then the user may engage in an interaction with a customer support representative. The user may express the intent by asking a question, for example, “I would like to place an order for a laptop with express shipping as I need the laptop sooner but, there is no option for express shipping coming up online”. In another example, if the intent of user is to change the shipping address but the user (even after accessing a portion of the website or the entire website) is unable to find any option to change the shipping address then the user may engage in an interaction with a customer support representative. The user may express this intent by asking a question, for example, “I want to change my shipping address but there is no option where I can update my shipping address”. The customer support representative may then provide the answers or solutions to the queries asked by the users. Accordingly, the interaction data may include a plurality of question asked by the users along with the corresponding answers provided by the customer support representatives.

In an embodiment, the memory 204 is further configured to receive the plurality of the user parameters associated with the plurality of users from at least one of the customer support center and the websites being visited by the plurality of users. The memory 204 is further configured to store the plurality of user parameters. In an embodiment, a user parameter from among the plurality of user parameters corresponds to one of user location information, user profile information, information related to a user journey on the interaction medium and a user preference information. The user location information may include geographical information associated with the user, such as for example at least one of a country, state, city, street-level location information corresponding to the user. The user profile information may include user related information, such as for example, user name, billing address, contact numbers, commonly used IP addresses, social networking account IDs, Email IDs and the like. The information related to the user journey on the interaction medium may include, for example, a user web journey or a path (or sequence) of web pages and decision points a user has followed while using a particular website. The user preference information may include information related to user inclination towards particular products or services, transaction options, devices for conduction interaction, channels for conducting interaction (for example, a channel from one among a SMS channel, an Email channel, a voice channel, a chat channel, a Web channel and the like), timings for conducting interactions (for example, preferred day of the week or time of the day, such as lunch hour or evenings during weekdays and mornings during weekends) and the like.

In an embodiment, the processor 202 is configured to receive the interaction data and the plurality of parameters from the memory 204. In an embodiment, the processor 202 is configured to, with the content of the memory 204, cause the apparatus 200 to generate a plurality of clusters from the interaction data based on the plurality of user parameters such that, each cluster is associated with at least one user parameter, and, each cluster includes one or more questions from among the plurality of questions asked during the interactions along with the corresponding answers. The one or more questions and the corresponding answers are related to the one or more user parameters associated with the corresponding cluster. More specifically, the questions asked by each user during the chat interactions may be associated with the one or more user parameters associated with the users to facilitate in generation of one or more clusters. The interaction data may be clustered based on the one or more parameters such that each cluster includes questions asked by the users during the interaction specific to those parameters. For example, the interaction data (including questions asked during the chat interaction) related to a specific domain and associated with same or similar parameters such as web journey, questions asked across the web journey, location, price, category, and the like, may be clustered as one cluster/group. In an embodiment, the processor 202 is configured to, with the content of the memory 204, cause the apparatus 200 to partition the interaction data into homogeneous groups based on the parameters associated with the users such that similar questions occurring at roughly similar points in a Web journey can be kept in one or more clusters or groups. In an embodiment, the interaction data is partitioned based clustering algorithm such as partitioning clustering algorithm, hierarchical clustering algorithm, distance-based clustering algorithm and density-based clustering algorithm.

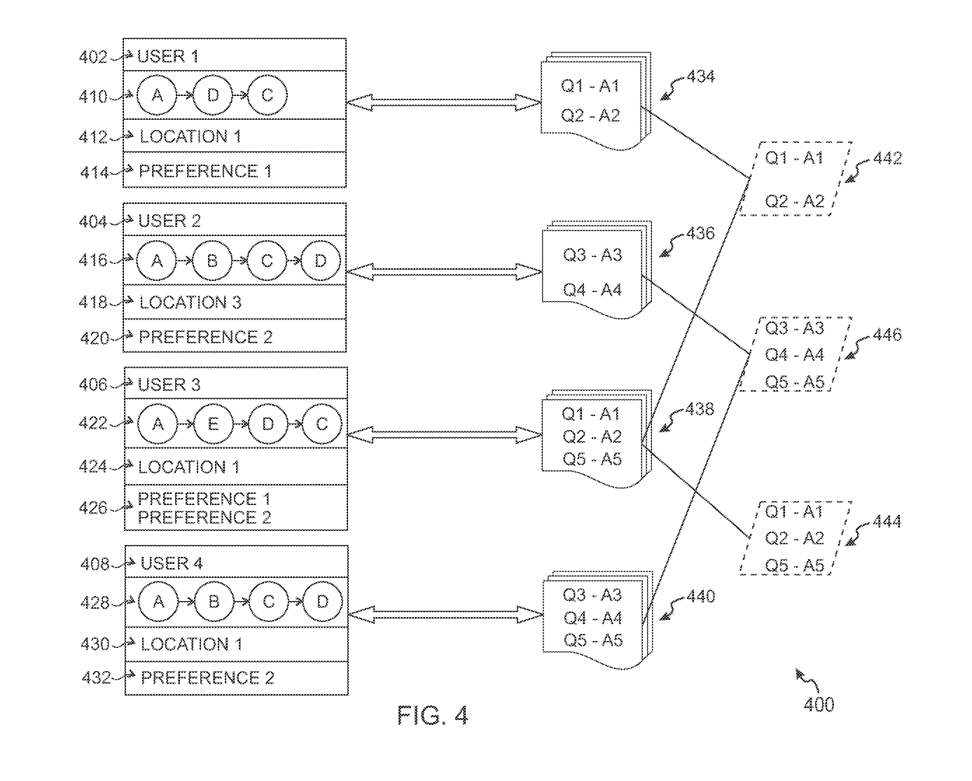

In an embodiment, the processor 202 is configured to, with the content of the memory 204, cause the apparatus 200 to normalize textual content associated with the one or more questions and the corresponding answers in each cluster for at least one of content language and context. For example, one or more questions and the answers in the interaction data may be specific to the corresponding conversations between the users and the customer support representatives and may not make sense in an isolated form upon partitioning the interaction data into clusters. In an illustrative example, a user may request express shipping options of a laptop, as he would be on business travel the next week. Such a question may be normalized for context to reflect a question on express shipping options. The reason for requesting express shipping options may be particular to the context to the specific interaction and as such may be precluded during normalization. Similarly, the questions and answers may include abbreviations, short forms, usage of slangs/lingos, typological errors and the like. In an illustrative example, a question posed by the user to the customer support representative during a chat interaction may be as follows: ‘wht r the annual mainteanance fees on Macs?’ In such a case, the short forms like ‘wht r’ may be normalized to ‘what are’, the word ‘mainteanance’ may be normalized for typological error to ‘maintenance’ and the lingo ‘Macs’ may be normalized to ‘Macbooks’, to reflect the question as ‘What are the annual maintenance fees on Macbooks?’ The answers provided by the customer support representatives may similarly be normalized. The processor 202 is configured to, with the content of the memory 204, cause the apparatus 200 to normalize the textual content associated with the one or more questions and the corresponding answers in each cluster for content language and context and store the curated questions and answers corresponding to each cluster in the memory 204. The generation of clusters is further explained with reference to FIG. 4.

In an embodiment, the processor 202 is configured to, with the content of the memory 204, cause the apparatus 200 to determine one or more visitor parameters corresponding to a visitor on an interaction medium. In an embodiment, the processor 202 is configured to, with the content of the memory 204, cause the apparatus 200 to determine an interaction medium access event corresponding to the visitor prior to determining the one or more visitor parameters. In an embodiment, the interaction medium is one of a website, a web portal and a native mobile application. In an illustrative example, the apparatus 200 may be configured to track functional calls to applets in electronic devices for detecting a native device application access event. In another illustrative example, a uniform resource locator (URL) based connection request at a web server hosting the website by the visitor may be tracked for detecting the website access event. It is noted that such examples of detection of the interaction medium access event is included herein for illustration purposes and one or more such standard techniques may be employed for detection of the interaction medium access event by the visitor. In an embodiment, the apparatus 200 is configured to determine the one or more visitor parameters upon determining the interaction medium access event. In an embodiment, a visitor parameter corresponds to one of visitor location information, visitor profile information, information related to a visitor journey on the interaction medium and visitor preference information. In an embodiment, visitor parameters may be similar to the user parameters explained above. More specifically, the visitor parameters, such as the visitor location information, visitor profile information, information related to a visitor journey on the interaction medium and visitor preference information may be similar to the user location information, user profile information, information related to a user journey on the interaction medium and user preference information, respectively, and are not explained herein. In an embodiment, the apparatus 200 is capable of configuring a socket connection to the visitor's electronic device to capture one or more visitor parameters. In an embodiment, the apparatus 200 may be configured to include hypertext markup language (HTML) and/or JavaScript based tags in a website content to determine visitor parameters, such as the visitor preference information or the visitor journey on the interaction medium, such as the website.

In an embodiment, the processor 202 is configured to, with the content of the memory 204, cause the apparatus 200 to identify at least one cluster to be related to the visitor from among the plurality of clusters based on the one or more visitor parameters. In an embodiment, the processor 202 is configured to, with the content of the memory 204, cause the apparatus 200 to compare the one or more visitor parameters with the user parameters associated with each cluster for a match, and, identify one or more matching clusters from among the plurality clusters as clusters to be related to the visitor. For example, the apparatus 200 may be configured to match the one or more visitor journey parameters with similar or substantially similar user journey parameters to identify the one or more clusters (including question and answer pairs) to be related to the visitor. In an illustrative example, user parameters associated with a cluster 1 may be location 1 and preference 1. If a visitor is determined to be associated with visitor parameters corresponding to location 1 and preference 1, then the cluster 1 may be identified to be the cluster related to the visitor. One or more such clusters may be identified to be related to the visitor. In an embodiment, the identification of the at least one cluster related to the visitor (for example, a matching of the one or more visitor parameters to the user parameters associated with each cluster) may be performed in real-time (or in an online manner) during an on-going visitor journey, whereas the generation of clusters may be performed previously in an offline manner (i.e. prior to the detection of the interaction medium access event corresponding the visitor). Alternatively, in an embodiment, the apparatus 200 may be configured to generate the plurality of clusters and identify at least one cluster related to the visitor from among the plurality of clusters in real-time during an on-going visitor journey.

In an embodiment, the processor 202 is configured to, with the content of the memory 204, cause the apparatus 200 to generate at least one frequently asked question (FAQ) based on the identified one or more clusters related to the visitor. In an embodiment, at least one FAQ is generated from one or more question-answer pairs associated with one or more clusters that are identified to be related to the visitor. The term ‘generation of FAQs’ as used herein may refer to retrieval of appropriate question-answer pairs (for example, subsequent to the normalization of question-answer pairs) from among the one or more question-answer pairs associated with the identified one or more clusters. In an embodiment, the generated FAQs are embodied as a list of question-answer pairs, which may be sorted based on relevance to the visitor. The term ‘generation of FAQs’ as used herein may also include sorting of the list of question-answer pairs based on the one or more visitor parameters so as to provide effective FAQs specific to the visitor and their web journey. For example, the FAQs that are more related to the visitor parameters are ranked first followed by the less related FAQs in the list. In an embodiment, the apparatus 200 is configured to automatically generate the one or more FAQs precluding manual intervention based on the identified one or more clusters related to the visitor.

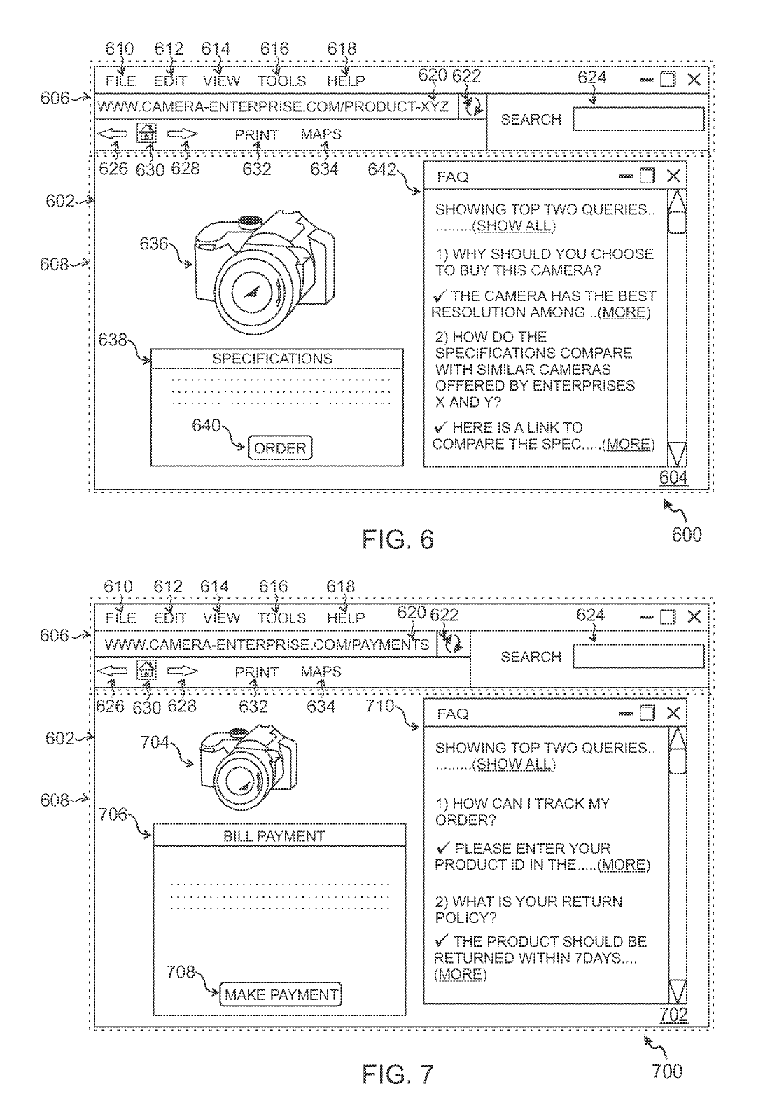

In an embodiment, the processor 202 is configured to, with the content of the memory 204, cause the apparatus 200 to provide the generated at least one FAQ to the visitor on the interaction medium. In an embodiment, the provisioning of the one or more FAQs includes facilitating a display of the one or more FAQs, for example on a visitor device screen, in a pop-up window, in an interactive widget, an infographic, a dedicated user interface (UI) and a portion of currently viewed UI associated with the interaction medium and the like. The provisioning of the one or more FAQs is further explained with reference to FIGS. 6 and 7. In an embodiment, the processor 202 is configured to, with the content of the memory 204, cause the apparatus 200 to monitor the one or more visitor parameters during an ongoing visitor journey on the interaction medium for detecting changes in the one or more visitor parameters. In an embodiment, the processor 202 is configured to, with the content of the memory 204, cause the apparatus 200 to dynamically adapt the at least one FAQ to a current context of the ongoing visitor journey upon detecting the changes in the one or more visitor parameters. In an embodiment, the processor 202 is configured to, with the content of the memory 204, cause the apparatus 200 to provide the adapted at least one FAQ to the visitor at different instances of the ongoing visitor journey based on the current context of the ongoing visitor journey. In an embodiment, processor 202 is configured to, with the content of the memory 204, cause the apparatus 200 to automatically populate/provide the best matching FAQs to the visitor listed in accordance to the relevance. An example sequence of operations performed by the apparatus 200 of FIG. 2 for generation of FAQs is explained with reference to FIG. 3.

FIG. 3 is a schematic diagram 300 showing an example sequence of operations performed by the apparatus 200 of FIG. 2 in accordance with an embodiment. The apparatus 200 is depicted to be communicably associated with a plurality of customer support representatives (exemplarily represented by block 302) and one or more visitors (exemplarily represented by block 304). The sequence of operations starts at operation 306. At operation 306, the apparatus 200 receives interaction data corresponding to interactions between a plurality of users and the customer support representatives. As explained with reference to FIG. 2, the interactions correspond to chat interactions between the plurality of users and the customer support representatives. For example, users may engage in chat interactions with customer support representatives through phones, chat applications, email, SMS and the like, such as to get solutions or suggestions related to a specific product or service. In an example embodiment, the chat interactions correspond to at least one of text chat interactions, voice chat interactions and video chat interactions. In an embodiment, the interaction data is embodied in a textual form and may include textual content corresponding to text chat interactions, transcripts of voice chat interaction, transcripts of video chat interaction and the like. The interaction data may include questions asked by the users and the corresponding answers provided by the customer support representatives as explained with reference to FIG. 2. Further, at operation 306, the apparatus 200 receives a plurality of user parameters associated with the plurality of users. The user parameters may correspond to one of user location information, user profile information, information related to a user journey on the interaction medium and a user preference information as explained with reference to FIG. 2.

At operation 308, the apparatus 200 generates a plurality of clusters from the interaction data based on the plurality of user parameters such that, each cluster is associated with at least one user parameter, and, each cluster includes one or more questions from among a plurality of questions asked during the interactions along with the corresponding answers. The one or more questions and the corresponding answers are related to the one or more user parameters associated with the corresponding cluster. More specifically, the questions asked by each user during the chat interactions may be associated with the one or more user parameters associated with the users to facilitate in generation of one or more clusters. The interaction data may be clustered based on the one or more parameters such that each cluster includes questions asked by the users during the interaction specific to those parameters. In an embodiment, the plurality of clusters is generated by partitioning the interaction data into homogenous groups using clustering algorithm such as partitioning clustering algorithm, hierarchical clustering algorithm, distance-based clustering algorithm and density-based clustering algorithm. At operation 308, the apparatus 200 also normalizes textual content associated with the one or more questions and the corresponding answers in each cluster for at least one of content language and context as explained with reference to FIG. 2.

At operation 310, the apparatus 200 determines one or more visitor parameters corresponding to a visitor on an interaction medium. The apparatus 200 may determine an interaction medium access event prior to determining the one or more visitor parameters as explained with reference to FIG. 2. In an embodiment, a visitor parameter corresponds to one of visitor location information, visitor profile information, information related to a visitor journey on the interaction medium and visitor preference information. In an embodiment, the apparatus 200 configures a socket connection to the visitor's electronic device to capture one or more visitor parameters. In an embodiment, the apparatus 200 is configured to include hypertext markup language (HTML) or JavaScript based tags in a website content to determine visitor parameters, such as the visitor preference information or the visitor journey on the interaction medium, such as the website.

At operation 312, the apparatus 200 identifies at least one cluster to be related to the visitor from among the plurality of clusters based on the one or more visitor parameters. In an embodiment, the apparatus 200 compares the one or more visitor parameters with the user parameters associated with each cluster for a match, and, identifies one or more matching clusters from among the plurality clusters as clusters to be related to the visitor. For example, the apparatus 200 may be configured match the one or more visitor journey parameters with similar or substantially similar user journey parameters to identify the one or more clusters (including questions and answer pairs) to be related to the visitor.

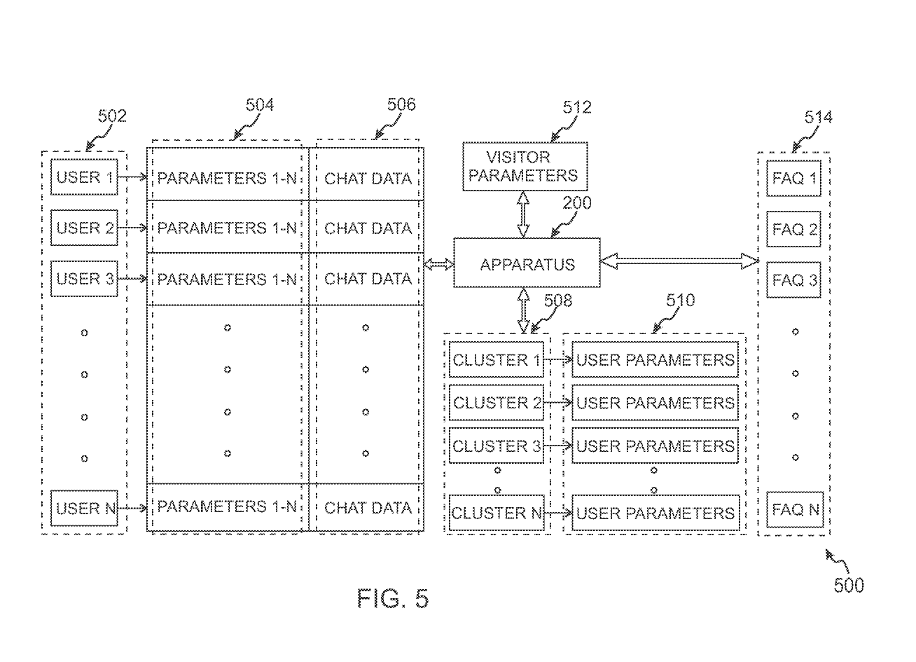

At operation 314, the apparatus 200 generates at least one FAQ based on the identified one or more clusters related to the visitor. In an embodiment, the at least one FAQ is configured to be generated from one or more question-answer pairs associated with one or more clusters that are identified to be related to the visitor. In an embodiment, the apparatus 200 automatically generates the one or more FAQs precluding manual intervention based on the identified one or more clusters related to the visitor. In an embodiment, the apparatus 200 may generate a set of one, two, three, four, five, or any number of FAQs. Further, an example illustration for generating FAQs by matching the visitor and the user parameters is explained with reference to FIG. 5. In an embodiment, the generated FAQs are embodied as a list of question-answer pairs.

At operation 316, the apparatus 200 performs the sorting of the list of question-answer pairs based on the one or more visitor parameters. For example, the FAQs that are more related to the visitor parameters are ranked first followed by the less related FAQs in the list. At operation 318, the apparatus 200 provides the best matching FAQs to the visitor listed in accordance to the relevance. In an embodiment, the provisioning of the one or more FAQs includes facilitating a display of the one or more FAQs in a pop-up window, in an interactive widget, an infographic, a dedicated user interface (UI) and a portion of currently viewed UI associated with the interaction medium and the like.

At operation 320, the apparatus 200 updates one or more clusters from among the plurality of clusters based on the one or more visitor parameters associated with the visitor. In an embodiment, based on the visitor parameters and other information received from the customer support representatives, the apparatus 200 may be configured to frequently optimize the interaction data corresponding to each cluster. At operation 322, the apparatus 200 monitors the one or more visitor parameters during an ongoing visitor journey on the interaction medium for detecting changes in the one or more visitor parameters. The apparatus 200 may further dynamically adapt the at least one FAQ to a current context of the ongoing visitor journey upon detecting the changes in the one or more visitor parameters. In an embodiment, the apparatus 200 provides the adapted at least one FAQ to the visitor at different instances of the ongoing visitor journey based on the current context of the ongoing visitor journey. It is noted that various blocks and operations described with reference to FIG. 3 may be performed in sequential order, simultaneously, parallel, or a combination thereof. Further, in some embodiments, some of the blocks and/or operations may be omitted, skipped, modified, or added without departing from scope of the present technology.

FIG. 4 illustrates a schematic diagram 400 for illustrating an example generation of clusters from interaction data in accordance with an embodiment. As explained with reference to FIG. 1, users visiting a website may not be satisfied from content present on the website and may prefer to interact with customer support representatives for obtaining product information, for receiving purchase assistance, for making customer service queries and the like. The users may engage in chat interactions with customer support representatives through phones, chat applications, email, SMS and the like. The schematic diagram 400 depicts a plurality of such users 402, 404, 406 and 408 (depicted as ‘user 1’, ‘user 2’, ‘user 3’ and ‘user 4’, respectively in FIG. 4).

Each user is depicted to be associated with a plurality of parameters, such as for example, parameters corresponding to user location information, user preference information and information related to user journey on the website. For example, user 1 is depicted to be associated with a web journey parameter 410 depicting the user 1 to have visited page A, page D and page C prior to initiating an interaction with a customer support representative. The user 1 is also associated with user location information parameter 412 and a user preference information parameter 414, which are depicted as location 1 and preference 1, respectively. Similarly, user 2 is depicted to be associated with a web journey parameter 416 depicting the user 2 to have visited page A, page B, page C and page D prior to initiating an interaction with a customer support representative. The user 2 is also associated with user location information parameter 418 and a user preference information parameter 420, which are depicted as location 3 and preference 2, respectively. The user 3 is depicted to be associated with a web journey parameter 422 depicting the user 3 to have visited page A, page E, page D and page C prior to initiating an interaction with a customer support representative. The user location information parameter 424 associated with user 3 is depicted as location 1, and, the user preference information parameter 426 associated with user 3 is depicted as preference 1 and preference 2. The user 4 is depicted to be associated with a web journey parameter 428 depicting the user 2 to have visited page A, page B, page C and page D prior to initiating an interaction with a customer support representative. The user 4 is also associated with user location information parameter 430 and a user preference information parameter 432, which are depicted as location 1 and preference 2, respectively.

Each interaction of the user with a customer support representative may include questions asked by the user and the corresponding answers provided by the customer support representative (for example, question (Q)-answer (A) pairs). For example, the user 1 may have asked questions, such as Q1 and Q2, to a customer support representative during an interaction, and may have received A1 and A2 as corresponding answers. The interaction data corresponding to each such interaction may accordingly include question-answer pairs. Accordingly in FIG. 4, the user 1 is depicted to be associated with interaction data 434 including Q1-A1 and Q2-A2 as corresponding question-answer pairs. Similarly, the user 2 is depicted to be associated with interaction data 436 including Q3-A3 and Q4-A4 as corresponding question-answer pairs. The user 3 is depicted to be associated with interaction data 438 including Q1-A1, Q2-A2 and Q5-A5 as corresponding question-answer pairs. The user 4 is depicted to be associated with interaction data 440 including Q3-A3, Q4-A4 and Q5-A5 as corresponding question-answer pairs.

As explained with reference to FIG. 2, the generation of the clusters from the interaction data by the apparatus 200 involves associating the question-answer pairs asked by users during the chat interactions with the one or more user parameters to generate the one or more clusters. In an embodiment, the interaction data (including question-answer pairs) related to a specific domain and associated with same or similar user parameters such as web journey, questions asked across the web journey, location, preferences, and the like, may be clustered as one cluster/group. For example, the users 1 and 3 are associated with substantially similar user parameters (for example, location 1 and preference 1 are common to both users and moreover, their web journeys include visits to pages A, D and C) and accordingly the interaction data related to the users 1 and 3 may be clustered into a single group 442 in FIG. 4 and referred to herein as cluster 1. The cluster 1 is depicted to include common question-answer pairs Q1-A1 and Q2-A2. The cluster 1 may be associated with user parameters, such as location 1 and preference 1 and web journey including visits to pages, A, D and C. Further, the question-answer pairs Q1-A1 and Q2-A2 in cluster 1 may be considered to be related to the user parameters associated with the cluster 1. Similarly, as user 3 is depicted to be associated with an additional user parameter in form of preference 2, the apparatus 200 may cluster such interaction data into another group 444 (referred to herein as cluster 2). The cluster 2 may be associated with user parameters, such as location 1, preferences 1 and 2 and web journey including visits to at least pages, A, D and C. Further, the question-answer pairs Q1-A1, Q2-A2 and Q5-A5 in cluster 2 may be considered to be related to the user parameters associated with the cluster 2. In other illustrative example shown in FIG. 4, the user 2 and user 4 are depicted to be associated with similar user parameter (for example, user parameters related to web journey information and user preference information). Accordingly, the interaction data related to the users 2 and 4 can be clustered into one single group 446 (referred to herein as cluster 3) including the question-answer pair Q3-A3, Q4-A4 and Q5-A5. It is understood that the clustering process described with respect to the FIG. 4 is only for illustrative purpose and does not limit the scope of the present technology. Further, it is noted that different combination of user parameters and partitioning techniques may be used to cluster the chat data. It is also understood that the schematic diagram 400 may include plurality of users, such as the users 402, 404, 406 and 408, and each user may be associated with fewer or more number of user parameters than the three user parameters depicted in FIG. 4.

FIG. 5 illustrates a schematic diagram 500 showing an example generation of FAQs in accordance with an embodiment. The schematic diagram 500 depicts a plurality of users 502 such as users 1, 2, 3 to N. Each user from among the plurality of users is associated with one or more user parameters (exemplarily depicted as ‘parameters 1-N’), which collectively configure a plurality of user parameters 504. Each user is further associated with chat data corresponding to one or more interactions with customer support representatives. The chat data corresponding to the plurality of users 502 collectively configure the interaction data 506. An apparatus, such as the apparatus 200 explained with reference to FIG. 2 is depicted to receive the plurality of user parameters 504 and the interaction data 506.

The apparatus 200 is configured to generate a plurality of clusters 508, such as clusters 1, 2, 3 to N from the interaction data 506 based on the parameters 1-N. The generation of clusters may be performed as explained with reference to FIG. 4 and is not explained herein. Each cluster is associated with one or more user parameters (collectively referred to herein as ‘user parameters’ 510). As explained with reference to FIGS. 2 to 4, each cluster includes one or more questions from among the plurality of questions asked during the interactions along with the corresponding answers. The one or more questions and the corresponding answers are related to the one or more user parameters associated with the corresponding cluster. More specifically, the interaction data 506 may be clustered based on the parameters 1-N such that each cluster includes questions asked by the users during the interaction specific to those parameters. The one or more questions and the corresponding answers in each cluster may be normalized for one of language content and context as explained with reference to FIG. 2.

In an embodiment, a visitor on an interaction medium, such as for example, but not limited to, a website, a web portal or a native mobile application may be associated with one or more visitor parameters. The apparatus 200 may be configured to determine the one or more visitor parameters (exemplarily depicted as ‘visitor parameters’ 512) associated with the visitor. In an embodiment, the apparatus 200 may be configured to compare the visitor parameters 512 to the user parameters 510 in order to determine a similar or substantially similar match. Further, the apparatus 200 is configured to identify at least one cluster from among the plurality of clusters 508 related to the visitor based on the matching of the visitor parameters 512 to the user parameters 510. In an embodiment, the apparatus 200 may be configured to generate a plurality of FAQs 514, such as FAQ 1, FAQ 2 to FAQ N based on the identified cluster(s) related to the visitor. As explained with reference to FIG. 2, the FAQs are generated from one or more question-answer pairs associated with one or more clusters that are identified to be related to the visitor. In an embodiment, the apparatus 200 is configured to automatically generate the one or more FAQs precluding manual intervention based on the identified one or more clusters related to the visitor. The generation of the FAQs is further explained with reference to an illustrative example below:

The apparatus 200 may include a cluster including questions and answers related to a restaurant and the cluster may be associated with a specific user location parameter (implying that one or more users from a particular location have typically asked questions related to the restaurant). For example, the cluster may include questions, such as for example, (1) ‘What are the timings for happy hour?’, (2) ‘Does the Restaurant offer delivery service?’, (3) ‘What credit cards are accepted here?’, (4) ‘How do I make reservations?’ and the like. Further, the cluster may also include answers provided by the customer support representatives to the corresponding questions. The apparatus 200 upon detecting a presence of a visitor on an interaction medium, such as for example a website, and further determining a user location parameter to be same as the user location parameter associated with the cluster, may generate one or more FAQs from the question-answer pairs included in the cluster.

The question-answer pairs in the plurality of FAQs 514 may be embodied as a list of question-answer pairs, which may further be sorted based on relevance to the visitor and the visitor's parameters. For example, the question (4) ‘Where do I make reservations?’ may be displayed (or provided) in the at least one FAQ 514 first and the question (3) ‘What credit cards are accepted here?’ may be displayed last in the list of question-answer pairs based on relevance associated with the visitor. In an embodiment, the apparatus 200 is configured to provide the generated plurality of FAQs 514 to the visitor on the interaction medium. In an embodiment, the provisioning of the plurality of FAQs 514 includes facilitating a display of the one or more FAQs in a visitor device screen, in a pop-up window, in an interactive widget, an infographic, a dedicated user interface (UI) and a portion of currently viewed UI associated with the interaction medium and the like.

In an embodiment, the apparatus 200 is configured to monitor the visitor journey on the website for detecting any change in the visitor parameters 512. The apparatus 200 is configured to dynamically adapt the plurality of FAQs 514 based on the current context of the visitor journey. For example, the visitor may wish to book a reservation in the restaurant and the website may direct the visitor to a new webpage including billing/payment related content. In such a scenario, a visitor web journey parameter associated with the visitor is updated and the apparatus 200 detects the change in the visitor web journey parameter. Further, the apparatus 200 may generate a new list of FAQs or update the earlier FAQs with one or more new set of question-answer pairs upon detecting the changes in the visitor web journey parameter and provide the updated FAQs to the visitor. The provisioning of the FAQs to the visitor is further explained with reference to FIGS. 6 and 7.

FIG. 6 illustrates a first example screenshot 600 of a visitor device screen showing example FAQs provided to a visitor in accordance with an embodiment. The screenshot 600 depicts a web browser 602 associated with the visitor's electronic device. Examples of the web browser 602 may include, but are not limited to popular web browsers, such as Internet Explorer® web browser, Safari® web browser, Chrome™ web browser and Mozilla® web browser or even proprietary web browsers. The web browser 602 is configured to display a web page 604 corresponding to a website that the visitor has visited. The web browser 602 includes a menu section 606 and webpage display section 608. The menu section 604 displays standard menu options such as “File 610”, “Edit 612”, “View 614”, “Tools 616” and “Help 618”. It is noted that the menu options are depicted for example purposes and that the menu section 606 may include fewer or more number of menu options than those displayed in FIG. 6. Further, each menu option may be configured to display upon clicking, a drop down list of secondary menu options. For example, upon clicking on the “File 610” menu option, a drop down list of secondary menu options (not shown in FIG. 6) such as “New Window”, “New Tab”, “Open location”, “Save As” and the like may be displayed. Each of the secondary menu options may be associated with an intended functionality. For example, the “New Window” secondary menu option may facilitate an opening of a new browser window. Similarly, the “Save As” secondary menu option may facilitate saving of the UI on display in one of various formats, such as for example a hyper text markup language (HTML) format or a text format. Each of the menu options such as “Edit 612”, “View 614”, “Tools 616” and “Help 618” may similarly include secondary menu options with associated functionalities.

The menu section 606 is further depicted to include a text box configured to receive user input in form of a web link, such as web link 620 (for example, web link exemplarily depicted as “WWW. CAMERA-ENTERPRISE.COM/PRODUCT-XYZ”). The web link 620 may trigger a hypertext transfer protocol (HTTP) request to fetch a desired web page, such as the web page 604, corresponding to a website from over the network, such as network 116 explained with reference to FIG. 1. It is noted that the fetching of the web page may involve standard procedures such as domain name resolutions using a domain name server (DNS) server and the like and are not discussed herein. The text box may further include a refresh icon 622 for re-sending the HTTP request for re-fetching the web page corresponding to the web application.

The menu section 606 further includes a text box 624 (also referred to herein as search box 624) configured to receive user input in form of a search request. In an embodiment, the search box 624 may be associated with one or more search engines, such as Google search engine, Yahoo search engine and/or Baidu search engine. Upon receiving user input in form of text for searching on the Internet, a web page including results of the search may be displayed to the user. Further, the menu section 606 includes a plurality of icons, such as icons 626, 628, 630, 632 and 634 providing quick access to a previously accessed webpage, a subsequently accessed page, a home page and a print page feature and a map feature, respectively.

The webpage display section 608 is configured to display web pages corresponding to the accessed website URLs. For example, the web page 604 is displayed upon accessing the URL “WWW.CAMERA-ENTERPRISE.COM/PRODUCT-XYZ”. The displayed webpage 604 is depicted to include graphic content 636 in form of an image of a camera device (referred to hereinafter as ‘camera’) and textual content 638 including specifications related to the camera. The textual content 638 corresponding to the specifications may include details such as for example, product name (for example, brand name), product identification number (for example, product ID or serial number), price and the like. The textual content 638 may also include a button 640 displaying the text “Order” and which upon being accessed is capable of facilitating online purchase of the camera.

As explained with reference to FIG. 2, the apparatus 200 is configured to detect interaction medium access event (for example, a website access event) of a visitor and determine one or more visitor parameters. The apparatus 200, upon determining the visitor parameters, may identify one or more clusters related to the visitor and generate FAQs based on the question-answer pairs included in the identified one or more clusters. The FAQs may be configured to include a list of question-answer pairs, which are sorted based on the relevance to the visitor and provided to the visitor on the interaction medium. Accordingly, upon determining the visitor parameters and the current context of the visitor web journey, the apparatus 200 may provide the FAQs in form of a list in a pop-up window 642. Since the visitor is seeking information on the camera displayed in the image content 636, it may be deduced that the visitor wishes to purchase a camera and is checking appropriate products prior to making the purchase. The FAQs provided in the pop-up window 642 may display the commonly asked questions along with corresponding answers for the current context of the visitor journey for assisting the visitor in making the purchase. For example, the top two questions in the list of FAQs in the pop-up window 642 are “Why should you choose to buy this camera?” and “How do the specifications compare with similar cameras offered by Enterprises X and Y?” Each question in the pop-up window 642 is associated with a corresponding answer. Such question-answer pairs provides effective assistance to the visitor by saving a customer's time in seeking answers to the specific queries the visitor may have given the current context of the visitor web journey, thereby enhancing a visitor experience on the website. It is noted that the provisioning of the FAQs in the pop-up window 642 is displayed herein for illustration purposes and it is understood that the FAQs may be provided to the visitors in various ways. For example, the FAQs may be provided as a list of question-answer pairs in an interactive widget, as an infographic, as a portion of the current webpage, a separate dedicated webpage and the like. Moreover, the FAQs may include any number of question-answer pairs.

Further, as explained with reference to FIG. 2, the apparatus 200 is configured to monitor the visitor journey on the website for detecting changes in the one or more visitor parameters and dynamically adapt the FAQs to the current context of the visitor journey. For example, if the visitor decides to click on the button 640 for purchasing the camera, then the web browser 602 may display a webpage related to payment or online billing of the camera as depicted in FIG. 7. The adapted FAQs provided to the visitor upon detecting a change in the visitor parameters is further explained with reference to FIG. 7.

FIG. 7 illustrates a second example screenshot 700 of the visitor device screen showing example FAQs provided to a visitor in accordance with an embodiment. The screenshot 700 depicts the web browser 602 associated with the visitor's electronic device. The web browser 602 and the various components of the web browser 602, such as the components 606-634 have already been explained with reference to FIG. 6, and are not explained herein for sake of brevity. For illustration purposes, the web browser 602 is configured to display a web page 702 corresponding to the URL “WWW.CAMERA-ENTERPRISE.COM/PAYMENTS”. As explained in FIG. 6, when the visitor clicks on the button 640, the visitor may be directed to a webpage associated with online billing of the camera, such as the webpage 702 depicted in FIG. 7.

The displayed webpage 702 is depicted to include graphical content 704 in form of the image of the camera (corresponding to the graphical content 636 in FIG. 6) along with textual content 706 facilitating a payment for purchase of the camera. In an example embodiment, the textual content 706 may list out the camera brand name and important details related to the camera. The textual content 706 may include icons for receiving preferred payment option from one among debit card based payment, credit card based payment, internet banking and the like. Furthermore, the textual content 706 may include a plurality of form fields capable of receiving visitor text input, such as for example details related to a name on the card, a card number, a card expiry date and a CVVC number. The textual content 706 may further include a button 708 displaying the text “Make payment”, which upon being accessed is capable of facilitating an authentication of the payment details provided by the visitor with a remote payment gateway for assisting in the purchase of the camera by the visitor.

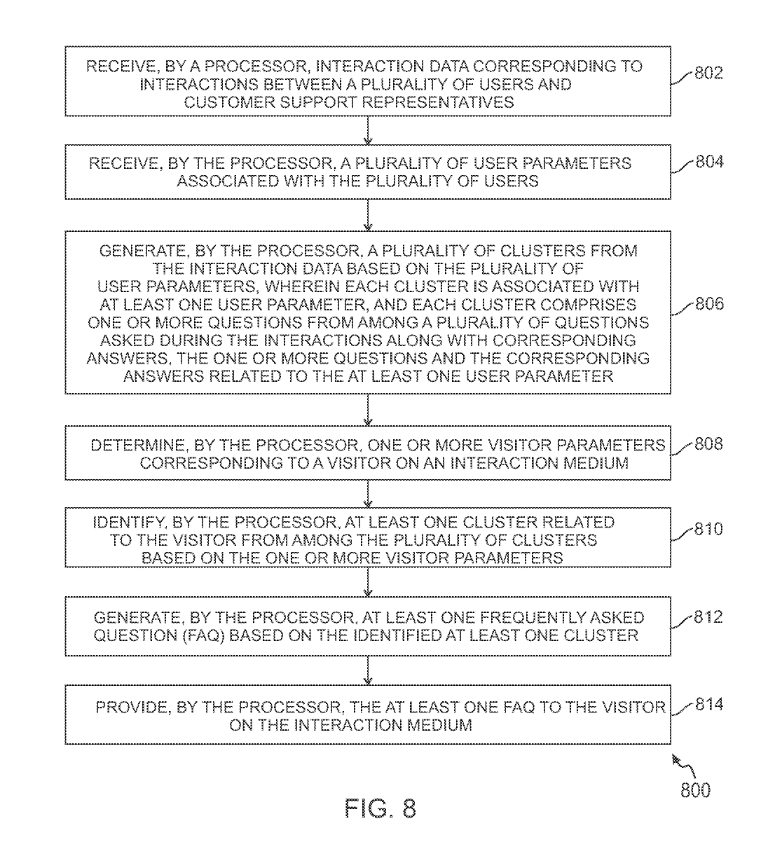

In an embodiment, the visitor upon accessing the webpage 702 may be automatically provided with updated FAQs in a pop-up window 710. As explained with reference to FIG. 6, the apparatus 200 is configured to monitor the visitor journey on the website for detecting changes in the one or more visitor parameters and dynamically adapt the FAQs to the current context of the visitor journey. Upon accessing the webpage 702, the visitor parameter corresponding to visitor journey on the website may change (i.e. reflect an additional visit to the webpage 702 from the webpage 604 displayed in example screenshot 600 of FIG. 6). Upon detecting the change in the visitor parameter, the apparatus 200 may learn a context of a current focus event of the visitor and appropriately retrieve question-answer pairs for display as FAQs in the pop-up window 710. Accordingly, upon learning the context of the current focus event to be billing/payment based on the detected change in the visitor parameter, the apparatus 200 may display the FAQs, such as “How can I track my order?” and “What is your return policy?” to the visitor in the pop-up window 710. Thus, the FAQs may be automatically generated and dynamically adapted to the current context of the visitor journey. As explained with reference to FIG. 6, it is noted that the provisioning of the FAQs in the pop-up window 710 is displayed herein for illustration purposes and it is understood that the FAQs may be provided to the visitors in various ways. For example, the FAQs may be provided as a list of question-answer pairs in an interactive widget, as an infographic, as a portion of the current webpage, a separate dedicated webpage and the like. Moreover, the FAQs may include any number of question-answer pairs. A method for facilitating generation of FAQ is explained with reference to FIG. 8.

FIG. 8 illustrates a flow diagram of a first example method 800 for generating FAQs in accordance with an example embodiment. The method 800 depicted in the flow diagram may be executed by, for example, the apparatus 200 explained with reference to FIGS. 2 to 7. Operations of the flowchart, and combinations of operation in the flowchart, may be implemented by, for example, hardware, firmware, a processor, circuitry and/or a different device associated with the execution of software that includes one or more computer program instructions. The operations of the method 800 are described herein with help of the apparatus 200. For example, one or more operations corresponding to the method 800 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 800 can be described and/or practiced by using an apparatus other than the apparatus 200. The method 800 starts at operation 802.

At operation 802, interaction data corresponding to interactions between a plurality of users and customer support representatives is received by a processor. In an embodiment, the interactions correspond to chat interactions between the plurality of users and the customer support representatives. For example, users may engage in chat interactions with customer support representatives through phones, chat applications, email, SMS and the like, such as to get solutions or suggestions related to a specific product or service. In an example embodiment, the chat interactions correspond to at least one of text chat interactions, voice chat interactions and video chat interactions. In an embodiment, the interaction data is embodied in a textual form and may include textual content corresponding to text chat interactions, transcripts of voice chat interactions, transcripts of video chat interactions and the like. In an embodiment, the interaction data may include questions asked by the users and the corresponding answers provided by the customer support representatives.

At operation 804, a plurality of user parameters associated with the plurality of users is received by the processor. In an embodiment, a user parameter from among the plurality of user parameters corresponds to one of user location information, user profile information, information related to a user journey on the interaction medium and a user preference information. The user location information may include geographical information associated with the user, such as for example at least one of a country, state, city, street-level location information corresponding to the user. The user profile information may include user related information, such as for example, user name, billing address, contact numbers, commonly used IP addresses, social networking account IDs, Email IDs and the like. The information related to the user journey on the interaction medium may include, for example, a user web journey or a path (or sequence) of web pages and decision points a user has followed while using a particular website. The user preference information may include information related to user inclination towards particular products or services, transaction options, devices for conduction interaction, channels for conducting interaction (for example, a channel from one among a SMS channel, an Email channel, a voice channel, a chat channel, a Web channel and the like), timings for conducting interactions (for example, preferred day of the week or time of the day, such as lunch hour or evenings during weekdays and mornings during weekends) and the like.

At operation 806, a plurality of clusters is generated from the interaction data based on the plurality of user parameters. In an embodiment, each cluster is associated with at least one user parameter, and, each cluster includes one or more questions from among a plurality of questions asked during the interactions along with the corresponding answers. The one or more questions and the corresponding answers are related to the one or more user parameters associated with the corresponding cluster. More specifically, the questions asked by each user during the chat interactions may be associated with the one or more user parameters associated with the users to facilitate in generation of one or more clusters. The interaction data may be clustered based on the one or more parameters such that each cluster includes questions asked by the users during the interaction specific to those parameters. For example, the interaction data (including questions asked during the chat interaction) related to a specific domain and associated with same or similar parameters such as web journey, questions asked across the web journey, location, price, category, and the like, may be clustered as one cluster/group. In an embodiment, the interaction data is partitioned into homogeneous groups based on the parameters associated with the users such that similar questions occurring at roughly similar points in a Web journey can be kept in one or more clusters or groups. In an embodiment, the interaction data is partitioned based on at least one clustering algorithm from among a partitioning clustering algorithm, hierarchical clustering algorithm, distance-based clustering algorithm and density-based clustering algorithm. In an embodiment, the textual content associated with the one or more questions and the corresponding answers in each cluster is normalized for at least one of content language and context as explained with reference to FIG. 2 and is not explained herein. The generation of the clusters may be performed as explained with reference to FIG. 4.

At operation 808, one or more visitor parameters corresponding to a visitor on an interaction medium are determined by the processor. In an embodiment, an interaction medium access event corresponding to the visitor is determined prior to determining the one or more visitor parameters as explained with reference to FIG. 2 and is not explained again herein. In an embodiment, a visitor parameter corresponds to one of visitor location information, visitor profile information, information related to a visitor journey on the interaction medium and visitor preference information. In an embodiment, visitor parameters may be similar to the user parameters explained above. More specifically, the visitor parameters, such as the visitor location information, visitor profile information, information related to a visitor journey on the interaction medium and visitor preference information may be similar to the user location information, user profile information, information related to a user journey on the interaction medium and user preference information. In an embodiment, the processor is capable of configuring a socket connection to the visitor's electronic device to capture one or more visitor parameters. In an embodiment, the processor may be configured to include hypertext markup language (HTML) or JavaScript based tags in a website content to determine visitor parameters, such as the visitor preference information or the visitor journey on the interaction medium, such as the website.

At operation 810, at least one cluster is determined to be related to the visitor from among the plurality of clusters by the processor based on the one or more visitor parameters. In an embodiment, the one or more visitor parameters are compared with the user parameters associated with each cluster for a match, and, one or more matching clusters are selected from among the plurality clusters as clusters to be related to the visitor. For example, the one or more visitor journey parameters are matched with similar or substantially similar user journey parameters to identify the one or more clusters (including questions and answer pairs) to be related to the visitor. As explained with reference to FIG. 2, in an embodiment, the identification of the at least one cluster related to the visitor (for example, a matching of the one or more visitor parameters to the user parameters associated with each cluster) may be performed in real-time (or in an online manner) during an on-going visitor journey, whereas the generation of clusters may be performed previously in an offline manner (i.e. prior to the detection of the interaction medium access event corresponding the visitor). Alternatively, in an embodiment, the generation of the plurality of clusters and the identification of at least one cluster related to the visitor from among the plurality of clusters is performed in real-time during an on-going visitor journey.

At operation 812, at least one FAQ is generated by the processor based on the identified at least one cluster. In an embodiment, one or more FAQs are generated from one or more question-answer pairs associated with one or more clusters that are identified to be related to the visitor. As explained with reference to FIG. 2, the term ‘generation of FAQs’ as used herein may refer to retrieval of appropriate question-answer pairs (for example, subsequent to the normalization of question-answer pairs) from among the one or more question-answer pairs associated with the identified one or more clusters. In an embodiment, the generated FAQs are embodied as a list of question-answer pairs, which may be sorted based on relevance to the visitor. In an embodiment, the list of question-answer pairs is sorted based on the one or more visitor parameters so as to provide effective FAQs specific to the visitor and their web journey. For example, the FAQs that are more related to the visitor parameters are ranked first followed by the less related FAQs in the list. In an embodiment, the one or more FAQs are automatically generated precluding manual intervention based on the identified one or more clusters related to the visitor. The generation of the FAQs may be performed as explained with reference to FIG. 5.

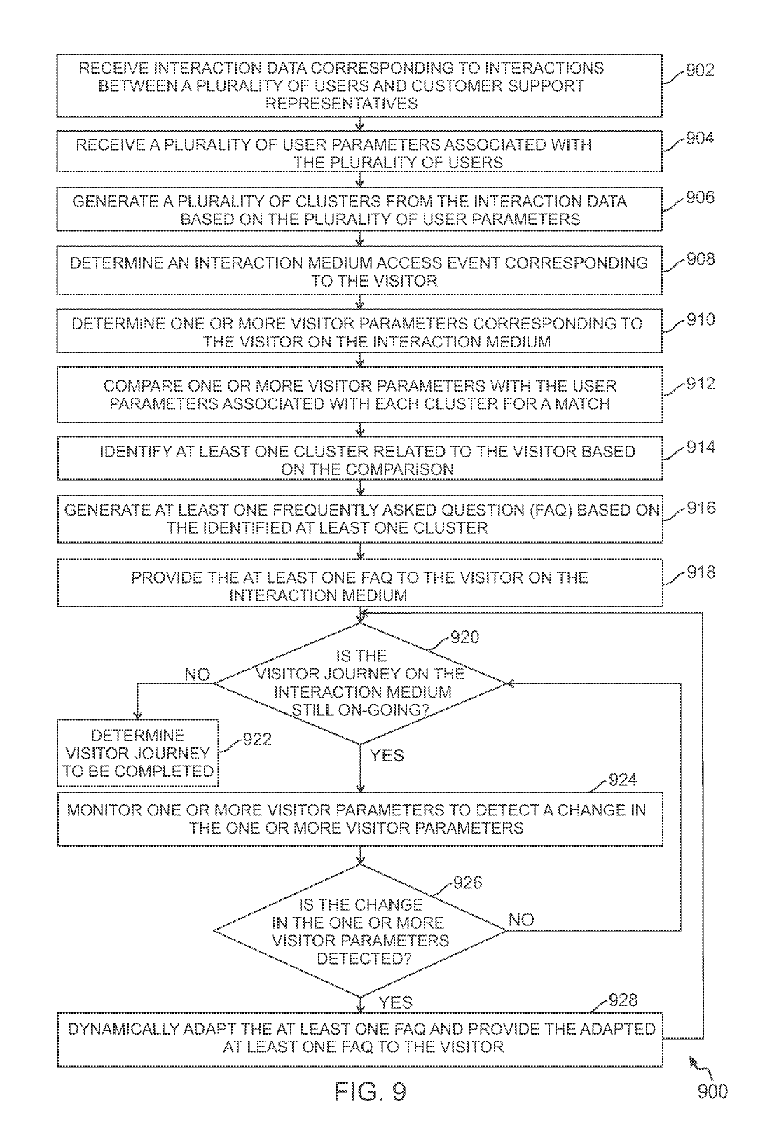

At operation 814, the generated at least one FAQ is provided to the visitor on the interaction medium. In an embodiment, the provisioning of the one or more FAQs includes facilitating a display of the one or more FAQs in a visitor device screen, for example, in a pop-up window, in an interactive widget, an infographic, a dedicated UI and a portion of currently viewed UI associated with the interaction medium and the like. The provisioning of the one or more FAQs may be performed as explained with reference to FIGS. 6 and 7. Another method for generating FAQs is explained with reference to FIG. 9.

FIG. 9 illustrates a flow diagram of a second example method 900 for generating FAQs in accordance with an example embodiment. The method 900 depicted in the flow diagram may be executed by, for example, the apparatus 200 explained with reference to FIGS. 2 to 7. Operations of the flowchart, and combinations of operation in the flowchart, may be implemented by, for example, hardware, firmware, a processor, circuitry and/or a different device associated with the execution of software that includes one or more computer program instructions. The operations of the method 900 are described herein with help of the apparatus 200. For example, one or more operations corresponding to the method 900 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 900 can be described and/or practiced by using an apparatus other than the apparatus 200. The method 900 starts at operation 902.

At operation 902, interaction data corresponding to interactions between a plurality of users and customer support representatives is received (for example, by the processor). At operation 904, a plurality of user parameters associated with the plurality of users is received (for example, by the processor). At operation 906, a plurality of clusters is generated from the interaction data based on the plurality of user parameters (for example, by the processor). The operations 902, 904 and 906 are similar to the operations 802, 804 and 806 explained with reference to method 800 in FIG. 8, respectively, and are not explained herein for sake of brevity.

At operation 908, an interaction medium access event corresponding to the visitor is determined by the processor. In an embodiment, the interaction medium is one of a website, a web portal and a native mobile application. In an illustrative example, functional calls to applets in electronic devices may be tracked (for example, by the processor) for detecting a native device application access event. In another illustrative example, a uniform resource locator (URL) based connection request at a web server hosting the website by the visitor may be tracked for detecting the website access event. It is noted that such examples of detection of the interaction medium access event is included herein for illustration purposes and one or more such standard techniques may be employed for detection of the interaction medium access event by the visitor.

At operation 910, one or more visitor parameters corresponding to a visitor on an interaction medium are determined (for example, by the processor). The operation 910 is performed as explained with reference to operation 808 in the method 800 of FIG. 8, and is not explained herein. At operation 912, the one or more visitor parameters are compared with the user parameters associated with each cluster of the plurality of clusters for a match by the processor. At operation 914, at least one cluster is identified to be related to the visitor from among the plurality clusters based on the comparison by the processor. For example, the one or more visitor journey parameters may be matched with similar or substantially similar user journey parameters to identify the one or more clusters (including question and answer pairs) to be related to the visitor.

At operation 916, at least one FAQ is generated (for example, by the processor) based on the identified at least one cluster. At operation 918, the generated at least one FAQ is provided to the visitor on the interaction medium (for example, by the processor). The operations 916 and 918 are performed as explained with reference to operations 812 and 814, respectively, in the method 800 of FIG. 8, and are not explained herein.

At operation 920, it is checked if a visitor journey on the interaction medium is still on-going by the processor. If the visitor journey is not detected to be on-going, then the visitor journey on the interaction medium is determined to be completed at operation 922 by the processor. If the visitor journey on the interaction medium is detected to be on-going, then at operation 924, one or more visitor parameters are monitored for detecting a change in the one or more visitor parameters by the processor. At operation 926, it is checked if the change in the one or more visitor parameters is detected by the processor. If no change in the one or more visitor parameters is detected, then operation 920 is performed till it is determined that the visitor journey on the interaction medium is completed. If the change in the one or more visitor parameters is detected at operation 926, then at operation 928, the at least one FAQ is dynamically adapted to the current context of the visitor journey and the adapted FAQs are provided to the user by the processor. The dynamic updating of the FAQs and the provisioning of the adapted FAQs to the visitor on the interaction medium may be performed as explained with reference to FIGS. 6 and 7. Upon provisioning of the adapted FAQs to the visitor, it is checked if the visitor journey is still on-going at operation 920 and the subsequent operations are repeated till it is determined that the visitor journey on the interaction medium is completed.

Without in any way limiting the scope, interpretation, or application of the claims appearing below, advantages of one or more of the exemplary embodiments disclosed herein include dynamic generation of FAQs for assisting online visitors. The FAQs may assist visitors with queries or concerns that the visitor may have (for example, while browsing on a website) and which may not be directly addressed by information present on the website. The techniques disclosed herein enable provision of effective FAQ's specific to the visitor based on one or more visitor parameters. In such a scenario, the visitor's time spent on the website may be decreased thereby facilitating an enhanced visitor experience and satisfaction quotient. The visitor's time may be reduced due to various reasons, such as for example, by precluding the visitor to fill pre-chat forms, wait for the chat to get connected and spend time in chatting with any customer support representative and the like. Further, the effective FAQ's may be dynamically updated based on the visitor profile and context such that, at any point of visitor's web journey, the visitor gets effective FAQ's specific to the current point in the visitor's web journey. Further, the FAQs are automatically generated with little or no human intervention thereby significantly reducing the time required to handle, analyze and generate the FAQ's manually or semi-manually.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method comprising:
receiving, by a processor, interaction data corresponding to interactions between a plurality of users and customer support representatives;
receiving, by the processor, a plurality of user parameters associated with the plurality of users;
generating a plurality of clusters from the interaction data based on the plurality of user parameters by the processor, wherein each cluster from among the plurality of clusters is associated with at least one user parameter from among the plurality of user parameters, and, wherein each cluster comprises one or more questions from among a plurality of questions asked during the interactions along with the corresponding answers, the one or more questions and the corresponding answers related to the at least one user parameter;
determining, by the processor, one or more visitor parameters corresponding to a visitor on an interaction medium;
identifying, by the processor, at least one cluster related to the visitor from among the plurality of clusters based on the one or more visitor parameters;
generating, by the processor, at least one frequently asked question (FAQ) based on the identified at least one cluster; and
providing, by the processor, the at least one FAQ to the visitor on the interaction medium.

2. The method of claim 1, wherein the interactions correspond to chat interactions between the plurality of users and the customer support representatives, and, wherein the chat interactions correspond to at least one of text chat interactions, voice chat interactions and video chat interactions.

3. The method of claim 1, wherein a user parameter from among the plurality of user parameters corresponds to one of user location information, user profile information, information related to a user journey on the interaction medium and a user preference information.

4. The method of claim 1, wherein the one or more questions in each cluster are associated with substantially similar instances of occurrences in user journeys associated with one or more users from among the plurality of users on the interaction medium.

5. The method of claim 1, wherein generating the plurality of clusters comprises partitioning the interaction data into homogenous groups based on the plurality of user parameters using at least one clustering algorithm from among a partitioning clustering algorithm, hierarchical clustering algorithm, distance-based clustering algorithm and density-based clustering algorithm.

6. The method of claim 1, wherein a visitor parameter from among the one or more visitor parameters corresponds to one of visitor location information, visitor profile information, information related to a visitor journey on the interaction medium and a visitor preference information.

7. The method of claim 1, wherein identifying the at least one cluster related to the visitor comprises comparing the one or more visitor parameters with the at least one user parameter associated with each cluster for a match, and, identifying one or more matching clusters from among the plurality clusters as the at least one cluster.

8. The method of claim 1, wherein the at least one FAQ is automatically generated precluding manual intervention based on the identified at least one cluster.

9. The method of claim 1, wherein the at least one FAQ comprises a list of question-answer pairs, the list of question-answer pairs sorted based on relevance to the visitor.

10. The method of claim 9, wherein the sorting of the list of question-answer pairs is performed based on the one or more visitor parameters.

11. The method of claim 1, wherein providing the at least one FAQ comprises facilitating a display of one or more question-answer pairs corresponding to the at least one FAQ on the interaction medium in one of a pop-up window, an interactive widget, an infographic, a dedicated user interface (UI) and a portion of currently viewed UI associated with the interaction medium.

12. The method of claim 1, wherein textual content associated with the one or more questions and the corresponding answers in each cluster is normalized for at least one of content language and context.

13. The method of claim 1, further comprising:
monitoring, by the processor, the one or more visitor parameters during an ongoing visitor journey on the interaction medium for detecting changes in the one or more visitor parameters;
dynamically adapting, by the processor, the at least one FAQ to a current context of the ongoing visitor journey upon detecting the changes in the one or more visitor parameters; and
providing, by the processor, the adapted at least one FAQ to the visitor at different instances of the ongoing visitor journey, the adapted at least one FAQ provided based on the current context of the ongoing visitor journey.

14. The method of claim 1, wherein the interaction medium is one of a website, a web portal and a native mobile application.

15. An apparatus comprising:
at least one processor; and
a memory having stored therein machine executable instructions, that when executed by the at least one processor, cause the apparatus to:
receive interaction data corresponding to interactions between a plurality of users and customer support representatives;
receive a plurality of user parameters associated with the plurality of users;
generate a plurality of clusters from the interaction data based on the plurality of user parameters, wherein each cluster from among the plurality of clusters is associated with at least one user parameter from among the plurality of user parameters, and, wherein each cluster comprises one or more questions from among a plurality of questions asked during the interactions along with the corresponding answers, the one or more questions and the corresponding answers related to the at least one user parameter;
determine one or more visitor parameters corresponding to a visitor on an interaction medium;
identify at least one cluster related to the visitor from among the plurality of clusters based on the one or more visitor parameters;
generate at least one frequently asked question (FAQ) based on the identified at least one cluster; and
provide the at least one FAQ to the visitor on the interaction medium.

16. The apparatus of claim 15, wherein the interactions correspond to chat interactions between the plurality of users and the customer support representatives, and, wherein the chat interactions correspond to at least one of text chat interactions, voice chat interactions and video chat interactions.

17. The apparatus of claim 15, wherein a user parameter from among the plurality of user parameters corresponds to one of user location information, user profile information, information related to a user journey on the interaction medium and a user preference information.

18. The apparatus of claim 15, wherein the one or more questions in each cluster are associated with substantially similar instances of occurrences in user journeys associated with one or more users from among the plurality of users on the interaction medium.

19. The apparatus of claim 15, wherein the apparatus is caused to generate the plurality of clusters by partitioning the interaction data into homogenous groups based on the plurality of user parameters using at least one clustering algorithm from among a partitioning clustering algorithm, hierarchical clustering algorithm, distance-based clustering algorithm and density-based clustering algorithm.

20. The apparatus of claim 15, wherein a visitor parameter from among the one or more visitor parameters corresponds to one of visitor location information, visitor profile information, information related to a visitor journey on the interaction medium and a visitor preference information.

21. The apparatus of claim 15, wherein the apparatus is further caused to compare the one or more visitor parameters with the at least one user parameter associated with each cluster for a match, and, identify one or more matching clusters from among the plurality clusters as the at least one cluster related to the visitor.

22. The apparatus of claim 15, wherein the apparatus is further caused to automatically generate the at least one FAQ precluding manual intervention based on the identified at least one cluster.

23. The apparatus of claim 15, wherein the at least one FAQ comprises a list of question-answer pairs, the list of question-answer pairs sorted based on relevance to the visitor.

24. The apparatus of claim 23, wherein the apparatus is further caused to perform the sorting of the list of question-answer pairs based on the one or more visitor parameters.

25. The apparatus of claim 15, wherein the apparatus is further caused to facilitate a display of one or more question-answer pairs corresponding to the at least one FAQ on the interaction medium in one of a pop-up window, an interactive widget, an infographic, a dedicated user interface (UI) and a portion of currently viewed UI associated with the interaction medium.

26. The apparatus of claim 15, wherein the apparatus is further caused to normalize textual content associated with the one or more questions and the corresponding answers in each cluster for at least one of content language and context.

27. The apparatus of claim 15, wherein the apparatus is further caused to:
monitor the one or more visitor parameters during an ongoing visitor journey on the interaction medium for detecting changes in the one or more visitor parameters;
dynamically adapt the at least one FAQ to a current context of the ongoing visitor journey upon detecting the changes in the one or more visitor parameters; and
provide the adapted at least one FAQ to the visitor at different instances of the ongoing visitor journey, the adapted at least one FAQ provided based on the current context of the ongoing visitor journey.

28. The apparatus of claim 15, wherein the interaction medium is one of a website, a web portal and a native mobile application.
